(19) United States
(12) Patent Application Publication
(10) Pub. No.: US 2023/0178742 A1
(43) Pub. Date: Jun. 8, 2023

(54) BINDER FOR NEGATIVE ELECTRODE OF RECHARGEABLE LITHIUM BATTERY AND RECHARGEABLE LITHIUM BATTERY INCLUDING SAME

(71) Applicant: SAMSUNG SDI CO., LTD., Yongin-si (KR)

(72) Inventors: Yunshik CHO, Yongin-si (KR); Seunghyun OH, Yongin-si (KR); Minho CHO, Yongin-si (KR); Kukjoo LEE, Yongin-si (KR); Kyunghwa JUNG, Yongin-si (KR); Jungmin LEE, Yongin-si (KR)

(21) Appl. No.: 18/061,916

(22) Filed: Dec. 5, 2022

(30) Foreign Application Priority Data
Dec. 7, 2021 (KR) 10-2021-0173966

(51) Int. Cl. H01M 4/62; H01M 4/133; C08F 212/08; C08F 220/18

(52) U.S. Cl. CPC H01M 4/622; C08F 212/08; C08F 220/1808; H01M 4/133; H01M 2004/027

(57) ABSTRACT

A binder for a negative electrode of a rechargeable lithium battery includes a copolymer of a styrene-based monomer and an acrylate-based monomer, wherein a mole ratio of the styrene-based monomer to the acrylate-based monomer is about 1:1 to about 1:3, and the binder has a swelling degree to an electrolyte of about 50 wt% or more to about 70 wt% or less.

### CROSS-REFERENCE TO RELATED APPLICATION

This application claims priority to and the benefit of Korean Patent Application No. 10-2021-0173966 filed in the Korean Intellectual Property Office on Dec. 7, 2021, the entire content of which is incorporated herein by reference.

### BACKGROUND

### 1. Field

One or more aspects of embodiments of the present disclosure relate to a binder for a negative electrode of a rechargeable lithium battery and a rechargeable lithium battery including the same.

### 2. Description of the Related Art

Recently, the rapid supply of electronic devices such as mobile phones, laptop computers, and/or electric vehicles, using batteries has led to a significant increase in demand for rechargeable batteries with relatively (suitably) high capacity and lighter weight. Particularly, a rechargeable lithium battery has recently drawn attention as a driving power source for portable devices, as it has lighter weight and high energy density.

A rechargeable lithium battery includes a positive electrode and a negative electrode which may include an active material being capable of intercalating and deintercalating lithium ions, and an electrolyte, and generates electrical energy due to an oxidation and reduction reaction when lithium ions are intercalated and deintercalated into the positive electrode and the negative electrode.

For a positive active material of a rechargeable lithium battery, transition metal compounds such as lithium cobalt oxides, lithium nickel oxides, and/or lithium manganese oxide are mainly used. As the negative active material, a crystalline carbonaceous material such as natural graphite and/or artificial graphite, or an amorphous carbonaceous material may be used.

One important aspect of improving performances of such rechargeable lithium batteries is to actively conduct the study (e.g., to develop) the battery capable of rapid charging. However, the rapid charging generally causes a decrease in the cycle-life, thereby causing capacity fading. To rectify these problems, materials and battery design capable of reducing internal resistance (e.g., heat caused by the resistance) of the battery are required (or desired), and particularly, development of a low-resistance binder for an electrode is desired.

The above information disclosed in this Background section is only for enhancement of understanding of the background of the invention, and therefore it may contain information that does not form the prior art that is already known in this country to a person of ordinary skill in the art.

### SUMMARY

One or more aspects of embodiments of the present disclosure are directed toward a binder for a negative electrode of a rechargeable lithium battery capable of improving impregnation of an electrolyte and minimizing (or reducing) resistance of a battery.

One or more aspects of embodiments are directed toward a negative electrode for a rechargeable lithium battery including the binder.

One or more aspects of embodiments are directed toward a rechargeable lithium battery including the negative electrode.

Additional aspects will be set forth in part in the description which follows and, in part, will be apparent from the description, or may be learned by practice of the presented embodiments of the disclosure.

One or more embodiments provide a binder for a negative electrode of a rechargeable lithium battery including a copolymer of a styrene-based monomer and an acrylate-based monomer, wherein a mole ratio of the styrene-based monomer to the acrylate-based monomer is about 1:1 to about 1:3, and the binder has a swelling degree to an electrolyte of about 50 wt% or more to about 70 wt% or less.

The styrene-based monomer may be styrene, α-methylstyrene, β-methylstyrene, p-t-butyl styrene, chlorostyrene, or a combination thereof. The acrylate-based monomer may be 2-ethylhexylacrylate, methyl(meth)acrylate, ethyl(meth)acrylate, propyl(meth)acrylate, isopropyl(meth)acrylate, n-butyl(meth)acrylate, isobutyl(meth)acrylate, n-amyl(meth)acrylate, isoamyl(meth)acrylate, n-hexyl(meth)acrylate, hydroxyethyl(meth)acrylate, hydroxypropyl(meth)acrylate, isobornyl acrylate, isovinyl acrylate, isovinyl methacrylate, or a combination thereof.

The binder may be an aqueous binder.

One or more embodiments provide a negative electrode including the binder and a negative active material.

One or more embodiments provide a rechargeable lithium battery including the negative electrode, a positive electrode, and an electrolyte.

The binder for a negative electrode of a rechargeable lithium battery may exhibit high energy density and excellent cycle-life characteristics.

### BRIEF DESCRIPTION OF THE DRAWINGS

FIG. 1 These and/or other aspects will become apparent and more readily appreciated from the following description of the embodiments, taken in conjunction with the accompanying drawing in which:

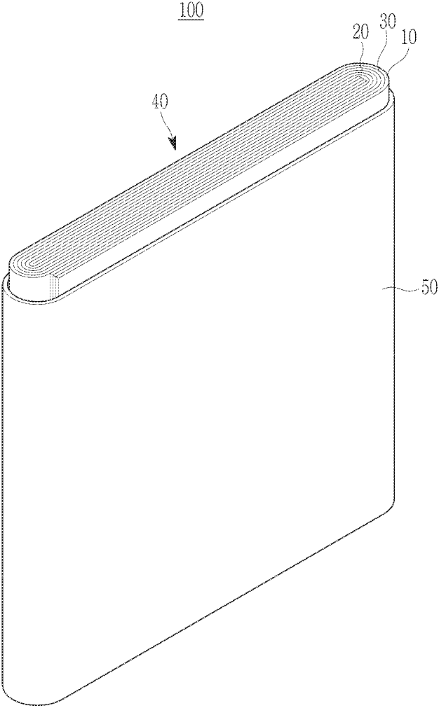

The drawing is a schematic view of a rechargeable lithium battery according to one or more embodiments.

### DETAILED DESCRIPTION

Hereinafter, embodiments of the present disclosure are described in more detail. However, these embodiments are merely examples, the present disclosure is not limited thereto, and the present disclosure is defined by the scope of the present claims and their equivalents.

It will be understood that, although the terms first, second, etc. may be used herein to describe various elements, these elements should not be limited by these terms. These terms are only used to distinguish one element from another element. Thus, a first element could be termed a second element without departing from the teachings of the present invention. Similarly, a second element could be termed a first element.

As used herein, the singular forms “a,” “an,” and “the” are intended to include the plural forms as well, unless the context clearly indicates otherwise.

It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the terms “use,” “using,” and “used” may be considered synonymous with the terms “utilize,” “utilizing,” and “utilized,” respectively.

As used herein, expressions such as “at least one of”, “one of”, and “selected from”, when preceding a list of elements, modify the entire list of elements and do not modify the individual elements of the list. For example, “at least one selected from a, b and c”, “at least one of a, b or c”, and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

As used herein, the term “and/or” includes any and all combinations of one or more of the associated listed items.

Further, the use of “may” when describing embodiments of the present disclosure refers to “one or more embodiments of the present disclosure”.

It will be understood that when an element is referred to as being “on,” “connected to,” or “coupled to” another element, it may be directly on, connected, or coupled to the other element or one or more intervening elements may also be present. When an element is referred to as being “directly on,” “directly connected to,” or “directly coupled to” another element, there are no intervening elements present.

Spatially relative terms, such as “beneath,” “below ,” “lower,” “above,” “upper,” “bottom,” “top” and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

As used herein, the terms “substantially”, “about”, and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ± 30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

The electronic device, the battery management device and/or any other relevant devices or components according to embodiments of the present invention described herein may be implemented utilizing any suitable hardware, firmware (e.g. an application-specific integrated circuit), software, or a combination of software, firmware, and hardware. For example, the various components of the apparatus may be formed on one integrated circuit (IC) chip or on separate IC chips. Further, the various components of the apparatus may be implemented on a flexible printed circuit film, a tape carrier package (TCP), a printed circuit board (PCB), or formed on one substrate. Further, the various components of the apparatus may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

A binder for a negative electrode of a rechargeable lithium battery may include a copolymer of a styrene-based monomer and an acrylate-based monomer. Herein, in the copolymer, a mixing ratio of the styrene-based monomer to the acrylate-based monomer may be about 1:1 to about 1:3 by mole ratio. As such, the binder according to one or more embodiments may include the acrylate-based monomer in the same amount or in a larger amount than (e.g., relative to) the styrene-based monomer. When the mixing ratio of the styrene-based monomer and the acrylate-based monomer falls into this range, excellent or improved impregnation to the electrolyte, low resistance, and excellent or improved room temperature and low temperature cycle-life characteristics may be exhibited.

The inclusion of a larger amount of the styrene-based monomer rather than the acrylate-based monomer in the binder may cause an increase of the electrode resistance and deterioration of low temperature capacity retention. Additionally, when the mixing ratio of the acrylate-based monomer to the styrene-based monomer is more than about 3, for example, more than about 3/1, the impregnation to the electrolyte may be increased, but the low temperature capacity retention may be deteriorated.

Furthermore, the binder may have a swelling degree to (e.g., with respect to) an electrolyte of about 50 wt% or more and about 70 wt% or less. When the binder has the swelling degree to the electrolyte within this range, excellent or improved impregnation to the electrolyte, low resistance, and excellent or improved room temperature and low temperature cycle-life characteristics may be exhibited.

In some embodiments, the mixing ratio of the styrene-based monomer and the acrylate-based monomer and the swelling degree to the electrolyte within both ranges of the present embodiments in the copolymer may allow to effectively or suitably maintain the adhesion to a current collector, and to exhibit decreased resistance, particularly decreased resistance at low temperatures, and excellent or improved room temperature and low temperature cycle-life characteristics. If any one of the mixing ratio of the styrene-based monomer and the acrylate-based monomer or the swelling degree to the electrolyte do not satisfy the above, the impregnation of the electrolyte and/or the adhesion to the current collector may be insufficient, thereby increasing resistance, and particularly deteriorating low temperature cycle-life characteristics.

In one or more embodiments, the styrene-based monomer may be styrene, α-methylstyrene, β-methylstyrene, p-t-butyl styrene, chlorostyrene, or a combination thereof. The styrene-based monomer according to one or more embodiments may include no (e.g., may exclude) butadiene, thereby improving high temperature stability of the negative electrode.

The acrylate-based monomer may be 2-ethylhexylacrylate, methyl(meth)acrylate, ethyl(meth)acrylate, propyl(meth)acrylate, isopropyl(meth)acrylate, n-butyl(meth)acrylate, isobutyl(meth)acrylate, n-amyl(meth)acrylate, isoamyl(meth)acrylate, n-hexyl(meth)acrylate, hydroxyethyl(meth)acrylate, hydroxypropyl(meth)acrylate, isobornyl acrylate, isovinyl acrylate, isovinyl methacrylate, or a combination thereof. In one or more embodiments, (meth)acrylate refers to methacrylate and/or acrylate. For example, methyl(meth)acrylate indicates methylmethacrylate and/or methylacrylate.

The acrylate-based monomer according to the present embodiments may reduce resistance. The increases in the swelling degree due to the use of the acrylate-based monomer may be suppressed or reduced by using the styrene-based monomer.

The binder according to one or more embodiments is a copolymer of the styrene-based monomer and the acrylate-based monomer. The copolymer may be synthesized by polymerizing the styrene-based monomer and the acrylate-based monomer, and may be a cross-linked copolymer in which the styrene-based monomer and the acrylate-based monomer are emulsion-polymerized in the polymerization process.

The binder according to one or more embodiments is the cross-linked copolymer, so that the swelling degree may be reduced. In one or more embodiments, the swelling degree to the electrolyte refers to a ratio of mass, e.g., a ratio of weight, after allowing the binder to stand, to the initial weight of the binder, and the weight after allowing the binder to stand is obtained by immersing a binder film into an electrolyte, heating, and allowing to stand for a set or predetermined amount of time.

The heating may be performed at about 50° C. to about 100° C.

The binder film may be prepared by drying a binder solution obtained during the binder preparation.

The electrolyte may be any suitable electrolyte that may be used in the rechargeable lithium battery. The set or predetermined amount of time (for which the binder is allowed to stand) may be about 24 hours to about 120 hours.

The binder according to one or more embodiments may have a surface contact angle to the electrolyte of about 20° to about 60°. The surface contact angle may be measured by dropping an electrolyte onto a binder film prepared using the binder in the same manner as with the measurement of the swelling degree. The electrolyte may be any suitable electrolyte that may be used in the rechargeable lithium battery.

The binder may be an aqueous binder. Thus, the binder may be suitably applicable to the negative electrode. As the positive active material is a relatively weak material in the aqueous system, it is not appropriate to apply the binder according to the present embodiments to the positive electrode.

The binder according to one or more embodiments may be prepared by polymerizing the styrene-based monomer, the acrylate-based monomer and a cross-linking agent in water. Herein, an emulsifier and an initiator may be further used.

The cross-linking agent may be a crosslinkable multi-functional monomer with two or more unsaturated groups such as divinylbenzene, ethylene glycol di(metha)acrylate, trimethylol propane tri(metha)acrylate, triallyl cyanurate, and/or the like; and/or a silane coupling agent with at least one ethylenic unsaturated bond, such as vinyl trimethoxy silane, vinyl triethoxy silane, ʏ-methacryloxy propyl trimethoxy silane, ʏ-methacryloxy propyl triethoxy silane, and/or the like. In one or more embodiments, the cross-linking agent may be divinylbenzene, trimethylolpropane tri(metha)acrylate, ʏ-methacryloxy propyltrimethoxysilane, or a combination thereof.

The emulsifier may be a higher fatty acid alkali salt, N-acrylamino acid salt, alkylether carboxylate, acylated peptide, alkyl sulfonate, alkylbenzene sulfonate, alkylamino acid salt, alkyl naphthalene sulfonate, sulfosuccinic acid salt, sulfonated oil, alkyl sulfate, alkyl ether sulfate, alkyl aryl ether sulfate, alkyl amide sulfate, alkyl phosphate, alkyl etherphosphate and/or alkyl aryl ether phosphate, or a combination thereof.

Examples of the emulsifier may include (e.g., be) sodium dodecylbenzene sulfonate.

The alkyl group may be a C1 to C20 alkyl group.

The initiator may be ammonium persulfate, potassium persulfate, hydrogen peroxide, t-butyl hydroperoxide, or a combination thereof.

An amount of the cross-linking agent may be about 0.01 parts by weight to about 3 parts by weight, or about 0.01 parts by weight to about 2 parts by weight based on the total amount (100 parts by weight) of the styrene-based monomer and the acrylate-based monomer. When the amount of the cross-linking agent is out of the range, the swelling degree may be too excessively (unsuitably or undesirably) increased or too excessively (unsuitably or undesirably) reduced.

An amount of the emulsifier may be about 0.1 parts by weight to 3 parts by weight, or 0.1 parts by weight to 2 parts by weight based on the total weight (100 wt% or parts by weight) of the styrene-based monomer and the acrylate-based monomer. When the amount of the emulsifier is within this range, the adhesion may be further improved and a binder having a sufficient or suitable size that is effectively or suitably distributed may be prepared.

An amount of the initiator may be about 0.1 parts by weight to about 3 parts by weight, or about 0.1 parts by weight to about 2 parts by weight based on the total weight (or 100 parts by weight) of the styrene-based monomer and the acrylate-based monomer.

A negative electrode according to the present embodiments includes the binder and a negative active material. For example, the negative electrode according to one or more embodiments includes a negative active material layer including the binder and the negative active material, and a current collector supported on the negative active material layer. The negative active material layer may be positioned on one or both sides of the current collector.

The negative active material includes a material that reversibly intercalates/deintercalates lithium ions, a lithium metal, a lithium metal alloy, a material capable of doping/dedoping lithium and/or a transition metal oxide.

The material that reversibly intercalates/deintercalates lithium ions may be a carbon material that may be any suitable carbon-based negative active material in a rechargeable lithium ion battery, and examples thereof may include crystalline carbon, amorphous carbon, and a combination thereof. Examples of the carbon material may include (e.g., be) crystalline carbon, amorphous carbon, and a mixture thereof. The crystalline carbon may be graphite such as unspecified shape, sheet shape, flake shape, spherical and/or fiber shaped natural graphite and/or artificial graphite, and the amorphous carbon may be soft carbon, hard carbon, mesophase pitch carbide, sintered cokes, and/or the like.

The soft carbon may be obtained from coal pitch, petroleum pitch, polyvinylchloride, mesophase pitch, tar, low molecular weight heavy oil, or any combination thereof.

The hard carbon may be obtained from a polyvinyl alcohol resin, a furfuryl alcohol resin, triton, citric acid, stearic acid, sucrose, polyvinylidene fluoride, carboxymethyl cellulose, hydroxypropyl cellulose, regenerated cellulose, polyvinyl pyrrolidone, polyethylene, polypropylene, ethylene-propylene-diene monomer (EPDM), polyacrylic acid, sodium polyacrylate, polyacrylonitrile, glucose, gelatin, saccharide, a phenol resin, a naphthalene resin, a polyamide resin, a furan resin, a polyimide resin, a cellulose resin, a styrene resin, an epoxy resin, a chloride vinyl resin, or any combination thereof.

The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, SiOₓ (0 < x < 2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, and is not Si), Sn, SnO₂, a Sn-R alloy (wherein R is an element selected from an alkali metal, an alkaline-earth metal, a Group 13 element, a Group 14 element, a Group 15 element, a Group 16 element, a transition metal, a rare earth element, and a combination thereof, and is not Sn), and/or the like. In some embodiments, at least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and a combination thereof.

The transition metal oxide may be vanadium oxide, lithium vanadium oxide, lithium titanium oxide, and/or the like.

According to one or more embodiments, the negative active material may be a Si-carbon composite, and the Si-carbon composite may include silicon particles and crystalline carbon. The silicon particle may have an average particle diameter D50 of about 10 nm to about 200 nm. The Si—C composite may further include an amorphous carbon layer formed on at least a portion of the Si—C composite. In the specification, when a definition is not otherwise provided, an average particle diameter (D50) indicates a diameter of particle where a cumulative volume is about 50 volume% in a particle distribution.

According to one or more other embodiments, the negative active material may be (e.g., may include) at least two negative active materials, and for example, may include the Si-carbon composite as a first negative active material and crystalline carbon as a second negative active material. When the negative active material includes at least two negative active materials, the mixing ratio thereof may be suitably controlled, for example, until an amount of Si is about 3 wt% to about 50 wt% based on the total weight of the negative active material.

The Si-carbon composite may include silicon and crystalline carbon. Herein, the silicon particle may have an average particle diameter D50 of about 10 nm to about 200 nm. The Si-carbon composite may further include an amorphous carbon layer formed on at least portion. In the specification, when a definition is not otherwise provided, an average particle diameter (D50) indicates a diameter of particles where a cumulative volume is about 50 volume% in a particle distribution. In the Si-carbon composite, an amount of silicon may be about 1 wt% to about 60 wt%.

The average particle size (D50) may be measured by a suitable method , for example, by a particle size analyzer, by a transmission electron microscopic image, and/or by a scanning electron microscopic image. Another method may be performed by using a measuring device with dynamic light scattering, analyzing data to count a number of particles relative to each particle size, and then calculating to obtain an average particle diameter D50.

Alternatively, the average particle diameter (D50) of the particles may be measured by laser diffraction (LD). The method may be performed according to ISO 13320-1. According to the IUPAC definition, the equivalent diameter of a non-spherical particle is equal to a diameter of a spherical particle that exhibits identical properties to that of the investigated non-spherical particle.

In the present specification, when particles are spherical, “diameter” indicates a particle diameter, and when the particles are non-spherical, the “diameter” indicates a major axis length.

The negative active material may include the silicon-based negative active material as a first negative active material, and a carbon-based negative active material as a second negative active material. Herein, the mixing ratio of the first negative active material to the second negative active material may be about a 1:99 to about a 50:50 weight ratio. For example, the negative active material may include the first negative active material and the second negative active material at a weight ratio of about 5:95 to about 20:80.

The carbon-based negative active material may be crystalline carbon, and the crystalline carbon may be artificial graphite, natural graphite, or a combination thereof.

An amount of the negative active material may be about 95 wt% to about 99 wt%, or about 92 wt% to about 97 wt%, based on 100 wt% of the negative active material layer.

An amount of the binder may be about 1 wt% to about 5 wt% based on the total (100 wt%) of the negative active material layer.

The negative active material layer may further include a conductive material. When the negative active material layer further includes a conductive material, the negative active material layer includes about 90 wt% to about 98 wt% of the negative active material, about 1 wt% to about 5 wt% of the binder, and about 1 wt% to about 5 wt% of the conductive material.

The conductive material is included to provide or improve electrode conductivity. Any suitable electrically conductive material may be used as a conductive material unless it causes a chemical change in the battery. The conductive material may include a carbon-based material such as natural graphite, artificial graphite, carbon black, acetylene black, ketjen black, a carbon fiber, and/or the like; a metal-based material of a metal powder and/or a metal fiber including copper, nickel, aluminum, silver, and/or the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal, and a combination thereof.

One or more embodiments provide a rechargeable lithium battery including the negative electrode, a positive electrode, and an electrolyte.

The positive electrode may include a current collector and a positive active material layer formed on the current collector.

The positive active material may include lithiated intercalation compounds that reversibly intercalate and deintercalate lithium ions. For example, one or more composite oxides of a metal selected from cobalt, manganese, nickel, and a combination thereof, and of lithium, may be used. In some embodiments, the compounds represented by one of the following chemical formulae may be used: LiₐA_{1-b}X_{b}D₂ (0.90≤a≤1.8, 0≤b<≤0.5); LiₐA_{1-b}X_{b}O₂-_{c}D_{c}(0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0 ≤ c ≤ 0.05); LiₐNi_{1-b-c}Co_{b}X_{c}D_{α} (0.90≤a≤1.8, 0≤ b ≤ 0.5, 0 ≤ c ≤0.5, 0<α≤2); LiₐNi_{1-b-} _{c}Co_{b}X_{c}O_{2-α}T_{α} (0.90≤a≤1.8, 0≤b≤0.5, 0≤c≤0.5, 0<α<2); LiₐNi_{1-b-c}Co_{b}X_{c}O_{2-α}T₂ (0.90≤a≤1.8, 0≤b≤0.5, 0 ≤c≤0.5, 0<α<2); LiₐNi_{1-b-c}Mn_{b}X_{c}D_{α}(0.90≤a≤1.8, 0≤b≤0.5, 0≤c≤0.5, 0<α≤2); LiₐNi_{1-b-c}Mn_{b}X_{c}O_{2-α}Tₐ (0.90≤a≤1.8, 0≤b≤0.5, 0≤c≤0.05, 0<α<2); LiₐNi₁₋ _{b-c}Mn_{b}X_{c}O_{2-α}T₂(0.90≤a≤1.8, 0≤b≤0.5, 0≤c≤0.5, 0<α<2); LiₐNi_{b}E_{c}G_{d}O₂(0.90≤a≤1.8, 0≤b≤0.9, 0≤c≤0.5, 0.001≤d≤0.1); LiₐNi_{b}Co_{c}Mn_{d}GₑO₂(0.90≤a≤1.8, 0≤b≤0.9, 0≤c≤0.5, 0≤d≤0.5, 0≤e≤0.1); LiₐNi_{b}Co_{c}Al_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li(_{3-f})Fe₂(PO₄)₃ (0≤f≤2); LiₐFePO₄ (0.90≤a≤1.8).

In the above chemical formulae, A is selected from Ni, Co, Mn, and combinations thereof; X is selected from Al, Ni, Co, Mn, Cr, Fe, Mg, Sr, V, a rare earth element, and combinations thereof; D is selected from O, F, S, P, and combinations thereof; E is selected from Co, Mn, and combinations thereof; T is selected from F, S, P, and combinations thereof; G is selected from Al, Cr, Mn, Fe, Mg, La, Ce, Sr, V, and combinations thereof; Q is selected from Ti, Mo, Mn, and combinations thereof; Z is selected from Cr, V, Fe, Sc, Y, and combinations thereof; and J is selected from V, Cr, Mn, Co, Ni, Cu, and combinations thereof..

The compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and/or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed (e.g., placed) in a method having no (or substantially no) adverse influence on properties of a positive active material by using these elements in the compound. For example, the method may include any suitable coating method such as spray coating, dipping, and/or the like, and corresponding details thereof should be well-known in the related field.

In the positive electrode, an amount of the positive active material may be about 90 wt% to about 98 wt% based on the total weight of the positive active material layer.

In one or more embodiments, the positive active material layer may further include a binder and a conductive material. Herein, the binder and the conductive material may be included in an amount of about 1 wt% to about 5 wt%, respectively, based on the total amount of the positive active material layer.

The binder improves binding properties of positive active material particles with one another and with a current collector. Examples of the positive active material binder may include polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene butadiene rubber, an acrylated styrene butadiene rubber, an epoxy resin, nylon, and the like, but are not limited thereto.

The conductive material is included to provide or improve electrode conductivity. Any suitable electrically conductive material may be used as a conductive material unless it causes a chemical change in the battery. Examples of the conductive material may include a carbon-based material such as natural graphite, artificial graphite, carbon black, acetylene black, ketjen black, a carbon fiber and/or the like; a metal-based material of a metal powder and/or a metal fiber including copper, nickel, aluminum, silver, and/or the like; a conductive polymer such as a polyphenylene derivative; or a mixture thereof.

The current collector may use Al, but is not limited thereto.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. The ketone-based solvent may include cyclohexanone, and/or the like. The alcohol-based solvent may include ethyl alcohol, isopropyl alcohol, and/or the like, and examples of the aprotic solvent may include nitriles such as R-CN (where R is a C2 to C20 linear, branched, or cyclic hydrocarbon, and/or may include a double bond, an aromatic ring, and/or an ether bond), amides such as dimethylformamide, dioxolanes such as 1,3-dioxolane, sulfolanes, and/or the like.

The organic solvent may be used alone or in a mixture. When the organic solvent is used in a mixture, the mixture ratio may be controlled in accordance with a desirable or suitable battery performance.

The carbonate-based solvent may include a mixture with a cyclic carbonate and a linear carbonate. The cyclic carbonate and linear carbonate are mixed together in a volume ratio of about 1:1 to about 1:9. When the mixture is used as an electrolyte, it may have enhanced performance.

The organic solvent may further include an aromatic hydrocarbon-based solvent as well as the carbonate-based solvent. The carbonate-based solvent and aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 1:

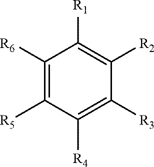

In Chemical Formula 1, R₁ to R₆ are the same or different and may each independently be selected from hydrogen, a halogen, a C1 to C10 alkyl group, a haloalkyl group, and combinations thereof.

Examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and combinations thereof.

The electrolyte may further include vinyl ethyl carbonate, vinylene carbonate, and/or an ethylene carbonate-based compound represented by Chemical Formula 2, as an additive for improving cycle life:

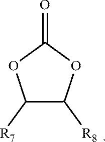

In Chemical Formula 2, R₇ and R₈ are the same or different and may each independently be hydrogen, a halogen, a cyano group (CN), a nitro group (NO₂), or a C1 to C5 fluoroalkyl group, provided that at least one of R₇ or R₈ is a halogen, a cyano group (CN), a nitro group (NO₂), or a C1 to C5 fluoroalkyl group, and R₇ and R₈ are not both (simultaneously) hydrogen.

Examples of the ethylene carbonate-based compound may include difluoro ethylene carbonate, chloroethylene carbonate, dichloroethylene carbonate, bromoethylene carbonate, dibromoethylene carbonate, nitroethylene carbonate, cyanoethylene carbonate, and fluoroethylene carbonate. An amount of the additive for improving the cycle-life characteristics may be within an appropriate or suitable range.

The lithium salt dissolved in an organic solvent supplies a battery with lithium ions, facilitates the operation the rechargeable lithium battery, and improves transportation of the lithium ions between a positive electrode and a negative electrode. Examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), where x and y are natural numbers, for example, an integer of about 1 to about 20, lithium difluoro(bisoxolato) phosphate), LiCl, Lil, LiB(C₂O₄)₂ (lithium bis(oxalato) borate: LiBOB), and lithium difluoro(oxalato)borate (LiDFOB). A concentration of the lithium salt may range from about 0.1 M to about 2.0 M. When the lithium salt is included at the above concentration range, an electrolyte may have excellent or suitable performance and lithium ion mobility due to optimal or suitable electrolyte conductivity and viscosity..

A separator may be disposed (e.g., provided) between the positive electrode and the negative electrode depending on a type (or kind) of a rechargeable lithium battery. The separator may use polyethylene, polypropylene, polyvinylidene fluoride, or multi-layers thereof having two or more layers, and may be a mixed multilayer such as a polyethylene/polypropylene double-layered separator, a polyethylene/polypropylene/polyethylene triple-layered separator, a polypropylene/polyethylene/polypropylene triple-layered separator, and/or the like.

The drawing is an exploded perspective view of a rechargeable lithium battery according to one or more embodiments of the present disclosure. The rechargeable lithium battery according to one or more embodiments is illustrated as a prismatic battery but is not limited thereto and may include variously-shaped suitable batteries such as a cylindrical battery, a pouch battery, and/or the like.

Referring to the drawing, a rechargeable lithium battery 100 according to one or more embodiments may include an electrode assembly 40 manufactured by winding a separator 30 disposed between a positive electrode 10 and a negative electrode 20, and a case 50 housing the electrode assembly 40. An electrolyte may be impregnated in the positive electrode 10, the negative electrode 20, and the separator 30.

Hereinafter, examples of the present disclosure and comparative examples are described. These examples, however, are not in any sense to be interpreted as limiting the scope of the present disclosure.

### Example 1

Styrene was mixed with 2-ethylhexylacrylate at a 1:1 mole ratio, and the resulting mixture, a sodium dodecylbenzene sulfonate emulsifier, divinylbenzene cross-linking agent, a potassium persulfate initiator and water were mixed. Herein, based on 100 parts by of the resulting mixture, the emulsifier was used at 0.3 parts by weight, the cross-linking agent was used at 0.1 parts by weight, and the initiator was used at 0.5 parts by weight.

Thereafter, the obtained mixture was emulsion polymerized to prepare a binder solution including a cross-linked copolymer of styrene and 2-ethylhexylacrylate.

The binder solution, a carboxymethyl cellulose thickener, and an artificial graphite negative active material were mixed with a water solvent to prepare a negative active material slurry. Herein, the binder solution was used so as to have an amount of the binder of 3 wt%. That is, the mixing process was performed to reach an amount of the binder to be 3 wt%, that of the thickener to be 1 wt% and that of the negative active material to be 94 wt%.

The negative active material slurry was coated on a copper foil current collector and dried, followed by pressing to prepare a negative electrode.

Using the negative electrode, a lithium metal counter electrode and a half-cell was fabricated by the general procedure (e.g., a suitable procedure that should be understood by those of ordinary skill in the art). As the electrolyte, a 1.5 M LiPF₆ dissolved in ethylene carbonate, ethyl methyl carbonate, and dimethyl carbonate (30:50:20 volume ratio) was used.

### Example 2

A binder solution was prepared by substantially the same procedure as in Example 1, except that a mole ratio of styrene and 2-ethylhexylacrylate was changed to 1:2.

A negative electrode and a half-cell were fabricated by substantially the same procedure as in Example 1, except for using the binder solution above.

### Example 3

A binder solution was prepared by substantially the same procedure as in Example 1, except that a mole ratio of styrene and 2-ethylhexylacrylate was changed to 1:3.

A negative electrode and a half-cell were fabricated by substantially the same procedure as in Example 1, except for using the binder solution above.

### Comparative Example 1

A binder solution was prepared by substantially the same procedure as in Example 1, except that a mole ratio of styrene and 2-ethylhexylacrylate was changed to 2:1.

A negative electrode and a half-cell were fabricated by substantially the same procedure as in Example 1, except for using the binder solution above.

### Comparative Example 2

A binder solution was prepared by substantially the same procedure as in Example 1, except that a mole ratio of styrene and 2-ethylhexylacrylate was changed to 3:1.

A negative electrode and a half-cell were fabricated by substantially the same procedure as in Example 1, except for using the binder solution above.

### Comparative Example 3

A binder solution was prepared by substantially the same procedure as in Example 1, except that a mole ratio of styrene and 2-ethylhexylacrylate was changed to 1:4.

A negative electrode and a half-cell were fabricated by substantially the same procedure as in Example 1, except for using the binder solution above.

### Comparative Example 4

Styrene was mixed with 2-ethylhexylacrylate at a 1:2 mole ratio, and the resulting mixture, a sodium dodecylbenzene sulfonate emulsifier, a potassium persulfate initiator and water were mixed. Herein, based on 100 parts by of the resulting mixture, the emulsifier was used at 0.3 parts by weight and the initiator was used at 0.5 parts by weight.

Using the mixture, a binder solution was prepared by substantially the same procedure as in Example 1, and a negative electrode and a half-cell were fabricated therefrom.

### Comparative Example 5

A negative electrode and a half-cell were fabricated by substantially the same procedure as in Example 2, except that the cross-linking agent was used at an amount of 5 parts by weight based on 100 parts by weight of the mixture.

### Comparative Example 6

3 wt% of styrene-butadiene rubber, 1 wt% of a carboxymethyl cellulose thickener, and 94 wt% of an artificial graphite negative active material were mixed in a water solvent to prepare a negative active material slurry.

A negative electrode and a half-cell were fabricated by substantially the same procedure as in Example 1, except for using the negative active material slurry prepared as above.

### Experimental Example 1. Measurement of Swelling Degree of Electrolyte

The binder solutions prepared by Examples 1 to 3 and the Comparative Examples 1 to 5 were dried to prepare binder films.

The binder film was impregnated into an electrolyte in which 1.5 M LiPF₆ was dissolved in a mixed solvent of ethylene carbonate, ethyl methyl carbonate and dimethyl carbonate (30:50:20 volume ratio), and allowed to stand at 70° C. for 3 days.

A weight ratio of the weight of the obtained binder film after allowing it to stand to the weight of the binder film before allowing it to stand was calculated. The results are shown in Table 1 as the swelling degree (%) of electrolyte.

### Experimental Example 2. Measurement of Contact Angle

10 µℓ of an electrolyte was dropped into the binder film prepared by Experimental Example 1, and an angle between the droplets on the film and the binder film were measured. The results are shown in Table 1 as a contact angle.

As the electrolyte, 1.5 M LiPF₆ dissolved in a mixed solvent of ethylene carbonate, ethyl methyl carbonate and dimethyl carbonate (30:50:20 volume ratio) was used.

TABLE 1

| | Mole ratio of styrene/2-ethylhexylacrylate | Swelling degree of electrolyte (%) | Contact angle (°) |
|---|---|---|---|
| Example 1 | 1/1 | 52 | 39 |
| Example 2 | 1/2 | 61 | 37 |
| Example 3 | 1/3 | 67 | 36 |
| Comparative Example 1 | 2/1 | 41 | 43 |
| Comparative Example 2 | 3/1 | 38 | 46 |
| Comparative Example 3 | 1/4 | 73 | 35 |
| Comparative Example 4 | 1/2 | 192 | 35 |
| Comparative Example 5 | 1/2 | 4 | 34 |

As shown in Table 1, Examples 1 to 3 in which (each) the (their) mole ratio of styrene and 2-ethylhexylacrylate was within the range of 1:1 to 1:3 had the swelling degree to electrolyte satisfying the range of 50 % to 70 % and the contact angle (°) within the range of 36° to 39°.

In contrast, Comparative Examples 1 to 3 in which the mole ratios of styrene and 2-ethylhexylacrylate were 2/1, 3/1, and 1/4, respectively, and Comparative Example 4 in which the cross-linking agent was not used, although the mole ratio of styrene and 2-ethylhexylacrylate was 1/2, exhibited the swelling degree to the electrolyte outside of the range of 50 % to 70 %. Comparative Example 5 in which 5 parts by weight — a relatively large amount — of the cross-linking agent was used, although the mole ratio of styrene and 2-ethylhexylacrylate which was ½, exhibited an extremely low swelling degree to the electrolyte of 4 %.

### Experimental Example 3. Measurement of Adherence

The adhesion strength of the negative active material layer to the current collector in the negative electrodes according to Examples 1 to 3 and Comparative Examples 1 to 6 was measured using a 180° UTM tensile strength tester by adhering a double-side tape adhered to a slide glass, to the positive electrode, to prepare a sample and measuring the sample with the tester. The results are shown in Table 2.

### Experimental Example 4. Measurement of DC Internal Resistance (DC-IR: Direct Current Internal Resistance)

The half-cells according to Examples 1 to 3 and Comparative Examples 1 to 6 were charged and discharged once by performing constant current/constant voltage charging under a condition of 0.2 C, 4.25 V, and a 0.05 C cut-off at -10° C., pausing for 10 minutes, and constant discharging under a condition of 0.33 C, and a 2.80 V cut-off, and pausing for 10 minutes. DC internal resistance (DC-IR) was evaluated by measuring a voltage drop (V) while a current flowed at 1 C for 1 second under a SOC50 (50 % charge capacity based on 100 % of entire battery charge capacity, which is 50 % discharged in a discharge state). The results are shown in Table 2.

### Experimental Example 5. Measurement of Room Temperature 25° C. and Low Temperature 10° C. Cycle-Life Characteristics

The half-cells according to Examples 1 to 3 and Comparative Examples 1 to 6 were charged and discharged at 1 C under a room temperature of 25° C. for 500 cycles. The ratio of discharge capacity at 500th to discharge capacity at 1^{st} were obtained. The results are shown in Table 2 as room temperature capacity retention.

The half-cells according to Examples 1 to 3 and Comparative Examples 1 to 6 were charged and discharged at 1 C under a low temperature of 10° C. for 500 cycles. The ratio of discharge capacity at 500th to discharge capacity at 1^{st} were obtained. The results are shown in Table 2 as low temperature capacity retentions.

TABLE 2

| | Adherence (gf/mm) | DC-IR (mΩ, -10° C.) | Room temperature of 25° C. capacity retention (%) | Low temperature of 10° C. capacity retention (%) |
|---|---|---|---|---|
| Example 1 | 1.03 | 208 | 93 | 89 |
| Example 2 | 1.01 | 203 | 93 | 91 |
| Example 3 | 0.95 | 199 | 92 | 88 |
| Comparative Example 1 | 1.01 | 218 | 92 | 81 |
| Comparative Example 2 | 1.02 | 224 | 91 | 79 |
| Comparative Example 3 | 0.88 | 197 | 90 | 83 |
| Comparative Example 4 | 1.03 | 193 | 88 | 76 |
| Comparative Example 5 | 0.75 | 235 | 71 | 58 |
| Comparative Example 6 | 1.05 | 227 | 92 | 77 |

As shown in Table 1, the half-cells of Examples 1 to 3 exhibited maintained adherence, low resistance, and excellent room temperature and low temperature capacity retentions.

In contrast, Comparative Examples 1 to 3 using larger amount of styrene than 2-ethylhexylacrylate, exhibited increased resistance, or deteriorated room temperature capacity retention and low temperature capacity retention. Comparative Example 3 using extremely large amount of 2-ethylhexylacrylate exhibited relatively high resistance and significantly reduced low temperature capacity retention.

Comparative Example 4 without the cross-linking agent, even if styrene and 2-ethylhexylacrylate were used at a suitable ratio according to the present embodiments, exhibited very high swelling degree to the electrolyte (see Table 1) and deteriorated room temperature capacity retention and low temperature capacity retention. Comparative Example 5 using too large an amount of the cross-linking agent, even though styrene and 2-ethylhexylacrylate were used at a suitable ratio according to the present embodiments, exhibited extremely low swelling degree to the electrolyte, severely increased resistance, deteriorated room temperature and significantly deteriorated low temperature capacity retentions.

While this disclosure has been described in connection with what is presently considered to be practical example embodiments, it is to be understood that the disclosure is not limited to the disclosed embodiments, but, on the contrary, is intended to cover various modifications and equivalent arrangements included within the spirit and scope of the appended claims, and equivalents thereof.

What is claimed is:

1. A binder for a negative electrode of a rechargeable lithium battery, the binder comprising:
a copolymer of a styrene-based monomer and an acrylate-based monomer,
wherein a mole ratio of the styrene-based monomer to the acrylate-based monomer is about 1:1 to about 1:3, and
the binder has a swelling degree to an electrolyte of about 50 wt% or more to about 70 wt% or less.

2. The binder of claim 1, wherein the styrene-based monomer is styrene, α-methylstyrene, β-methylstyrene, p-t-butyl styrene, chlorostyrene, or a combination thereof.

3. The binder of claim 1, wherein the acrylate-based monomer is 2-ethylhexylacrylate, methyl(meth)acrylate, ethyl(meth)acrylate, propyl(meth)acrylate, isopropyl(meth)acrylate, n-butyl(meth)acrylate, isobutyl(meth)acrylate, n-amyl(meth)acrylate, isoamyl(meth)acrylate, n-hexyl(meth)acrylate, hydroxyethyl(meth)acrylate, hydroxypropyl(meth)acrylate, isobornyl acrylate, isovinylacrylate, isovinyl methacrylate, or a combination thereof.

4. The binder of claim 1, wherein the copolymer is a cross-linked copolymer.

5. The binder of claim 1, wherein the binder is an aqueous binder.

6. A negative electrode, comprising:
the binder of claim 1; and
a negative active material.

7. A rechargeable lithium battery, comprising:
the negative electrode of claim 6;
a positive electrode; and
an electrolyte.
